(19) United States
(12) Patent Application Publication
(10) Pub. No.: US 2010/0073478 A1
(43) Pub. Date: Mar. 25, 2010

(54) VEHICLE MOUNTED DEVICES AND ARRANGEMENTS

(75) Inventor: D. Scott Kalous, Kenosha, WI (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: MASTER LOCK COMPANY LLC, Oak Creek, WI (US)

(21) Appl. No.: 12/400,934

(22) Filed: Mar. 10, 2009

Related U.S. Application Data
(60) Provisional application No. 61/099,305, filed on Sep. 23, 2008.

(51) Int. Cl. H04N 7/18; B60R 11/00; B60R 99/00

(52) U.S. Cl. 348/148; 280/762; 348/E07.085

(57) ABSTRACT

A trailer hitch mountable device for installation in a trailer hitch receiver tube includes a housing and a retainer bracket. The housing is sized to be received in the receiver tube and has an outermost wall including at least a first arcuate portion sized to align with circumferential edges of aligned mounting holes of the receiver tube when the device is installed in the receiver tube. The retainer bracket is secured to the housing and configured to engage an outermost edge of the receiver tube when the device is installed in the receiver tube. When the device is installed in the receiver tube and a receiver pin is inserted through the aligned mounting holes, the first arcuate portion prevents movement of the housing toward the outermost edge of the receiver tube, and the retainer bracket prevents movement of the housing away from the outermost edge of the receiver tube.

### CROSS-REFERENCE TO RELATED APPLICATION

This application claims the benefit of U.S. Provisional Patent Application Ser. No. 61/099,305, entitled “VEHICLE MOUNTED CAMERA SYSTEM” and filed Sep. 23, 2008, the entire contents of which are incorporated herein by reference, to the extent that they are not conflicting with the present application.

### BACKGROUND

Video monitoring of a vehicle's surroundings may be used for many different purposes, such as, for example, displaying a rear or side blind spot of the vehicle to the driver to alert the driver of people or objects in these blind spots. As another example, a camera may assist in parallel parking or aligning the vehicle with a trailer to facilitate hitch mounting. As still another example, a camera may be used to detect and identify individuals approaching the vehicle who may intend to vandalize or steal the vehicle.

### SUMMARY

While a camera may be built into a vehicle body during assembly of the vehicle, it may also be desirable for a consumer or retailer to mount a camera to a vehicle. This “after market” mounting of a camera to a vehicle may present challenges, such as, for example, the need to cut, machine, or alter the vehicle body to facilitate mounting, mounting the camera in such a way that minimizes risk of theft of, or damage to, the camera, or mounting of the camera to minimize vibration or other conditions that may distort or degrade the displayed image. In still other applications, it may be desirable to mount still other types of equipment and devices to an external surface of a vehicle without damaging or altering the vehicle.

According to an inventive aspect of the present application, a mountable device may be configured to be secured within a trailer hitch receiver tube, provided, for example, on a truck or sport utility vehicle. While the installed device may protrude from the end of the receiver tube, in one embodiment, the entire device may be received within the receiver tube, for example, to minimize the risk of damage resulting from impact with another object. To secure the device to the receiver tube (for example, to prevent theft of the device or loss of the device due to bumps or vibration while driving the vehicle), the device may be configured to be secured within the receiver tube by inserting a receiver tube hitch pin through aligned holes in the receiver tube. For example, a locking hitch pin (secured through the receiver tube mounting holes by a locking mechanism, such as for example, a key operated or combination dial lock) may be utilized to prevent unauthorized withdrawal of the hitch pin and removal of the device.

Accordingly, in one embodiment, a trailer hitch mountable device for installation in a trailer hitch receiver tube includes a housing and a retainer bracket. The housing is sized to be received in the receiver tube and has an outermost wall including at least a first arcuate portion sized to align with circumferential edges of aligned mounting holes of the receiver tube when the device is installed in the receiver tube. The retainer bracket is secured to the housing and configured to engage an outermost edge of the receiver tube when the device is installed in the receiver tube. When the device is installed in the receiver tube and a receiver pin is inserted through the aligned mounting holes, the first arcuate portion prevents movement of the housing toward the outermost edge of the receiver tube, and the retainer bracket prevents movement of the housing away from the outermost edge of the receiver tube.

### BRIEF DESCRIPTION OF THE DRAWINGS

Features and advantages of the invention will become apparent from the following detailed description made with reference to the accompanying drawings, wherein:

FIG. 1 is a perspective view of a mountable camera arrangement for a vehicle;

FIG. 2A is a side view of the camera arrangement of FIG. 1 assembled with an exemplary Class II receiver tube, with the receiver tube shown in cross-section;

FIG. 2B is a side view of the camera arrangement of FIG. 1 assembled with an exemplary Class III receiver tube, with the receiver tube shown in cross-section;

FIG. 3 is an exploded perspective view of the camera arrangement of FIG. 1;

FIG. 4 is a perspective view of a camera arrangement assembled with a receiver tube, including a trailer tow plug electrical connector;

FIG. 4A is a perspective view of an electrical connector for use with a mountable camera arrangement for a vehicle;

FIG. 4B is a perspective view of another electrical connector for use with a mountable camera arrangement for a vehicle;

FIG. 4C is a perspective view of still another electrical connector for use with a mountable camera arrangement for a vehicle;

FIG. 5 is a perspective view of the camera arrangement of FIG. 1, shown with the camera in a pivoted condition;

FIG. 6 is a perspective view of a camera arrangement mounted to an external surface of a vehicle;

FIG. 7A is a perspective view of a dashboard mountable display screen for receiving video signals from a vehicle mounted camera; and

FIG. 7B is a perspective view of a windshield mountable display screen for receiving video signals from a vehicle mounted camera.

### DETAILED DESCRIPTION OF THE DISCLOSURE

The present application contemplates mounting arrangements for securing a device to an external surface of a vehicle. While the specific embodiments described herein relate to the mounting of a camera to a vehicle for monitoring an area behind the vehicle (either directly or peripherally), various inventive features of the arrangements described herein may also be used to mount other devices to a vehicle, including, for example, auxiliary lights, speakers, sirens/alarms, safes/lockboxes, and motion sensors.

In an inventive aspect of the present application, a device may be configured to be mounted to a trailer hitch receiver tube. In one such embodiment, a mountable device includes a housing sized to be received in the receiver tube and configured to utilize a conventional trailer hitch pin for securing the housing within the receiver tube. While many different hitch pin engaging arrangements may be utilized, in one embodiment, a mountable device may include a housing having an outermost (i.e., facing the open end of the receiver tube when installed) wall including a pin bearing portion positioned to align with circumferential edges of the aligned mounting holes in the receiver tube, such that an inserted hitch pin engages the pin bearing portion to prevent movement of the housing toward the outermost edge or open end of the receiver tube. While the pin bearing portion may also prevent movement of the housing away from the open end of the receiver tube, in another embodiment, a retainer bracket may be secured to the housing and configured to engage the outermost edge of the receiver tube when the device is installed in the receiver tube, thereby preventing movement of the housing away from the outermost edge of the receiver tube (i.e., to prevent the device from sliding too far into the receiver tube).

According to another inventive aspect of the present application, a trailer hitch mountable device may be configured to be installed in more than one size receiver tube. In one embodiment, a device may be configured to be secured in any one of multiple receiver tubes having mounting holes that are dimensionally different (e.g., different size, shape, and/or location with respect to a bottom surface of the receiver tube). As one example, a device may be configured to be installed in both Class II (1.25 inch) and Class III (2 inch) receiver tubes. In one such embodiment, a housing of the device includes an outermost wall having first and second pin engaging portions. The first pin engaging portion is positioned to align with circumferential edges of aligned mounting holes in a receiver tube of a first size (e.g., a Class III receiver tube) when the device is installed in the receiver tube, and the second pin engaging portion is positioned to align with circumferential edges of aligned mounting holes in a receiver tube of a second size (e.g., a Class II receiver tube) when the device is installed in the receiver tube. A retainer bracket is connected to the housing and is configured to engage an outermost edge of at least one of the first and second receiver tubes when the device is installed in that receiver tube, thereby preventing movement of the housing away from the outermost edge of the receiver tube (i.e., sliding too far into the receiver tube).

According to still another inventive aspect of the present application, an electrically operable device having a controller portion and an interface portion may be configured to be mounted to a trailer hitch receiver tube. In one embodiment, a housing containing an electrically operable device controller (e.g., a wireless transmitter and/or control circuit) may be secured within a receiver tube, and an electrically operable device interface (e.g., a camera, sensor, siren, light source, or video display) electrically connected with the controller may be secured to a retainer bracket connected with the housing. The retainer bracket may be configured to engage an outermost edge of the receiver tube to control the position of the device interface and/or the controller.

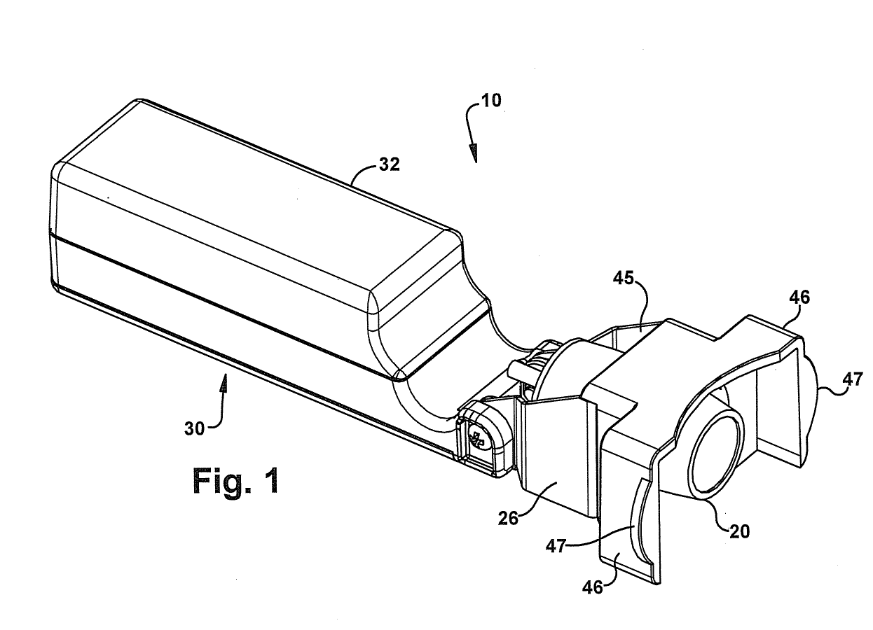

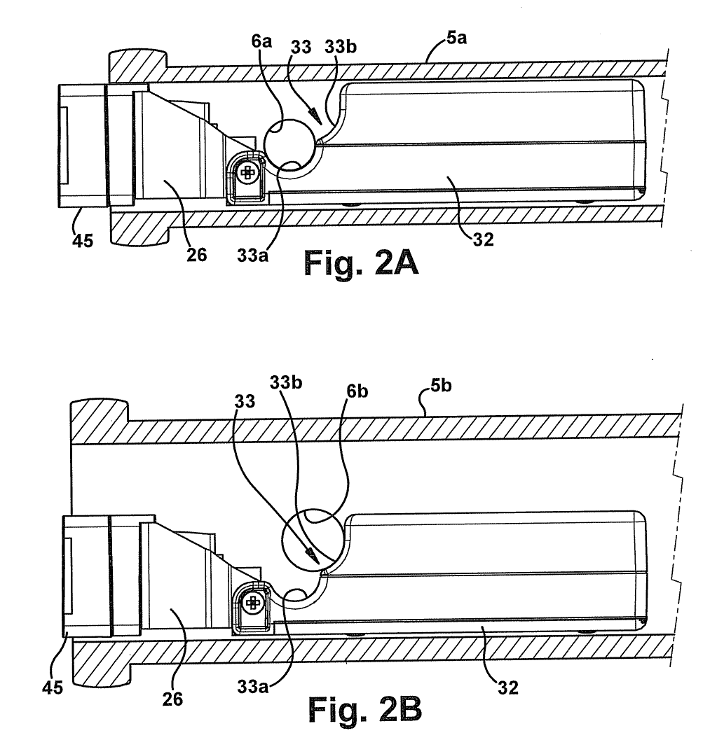

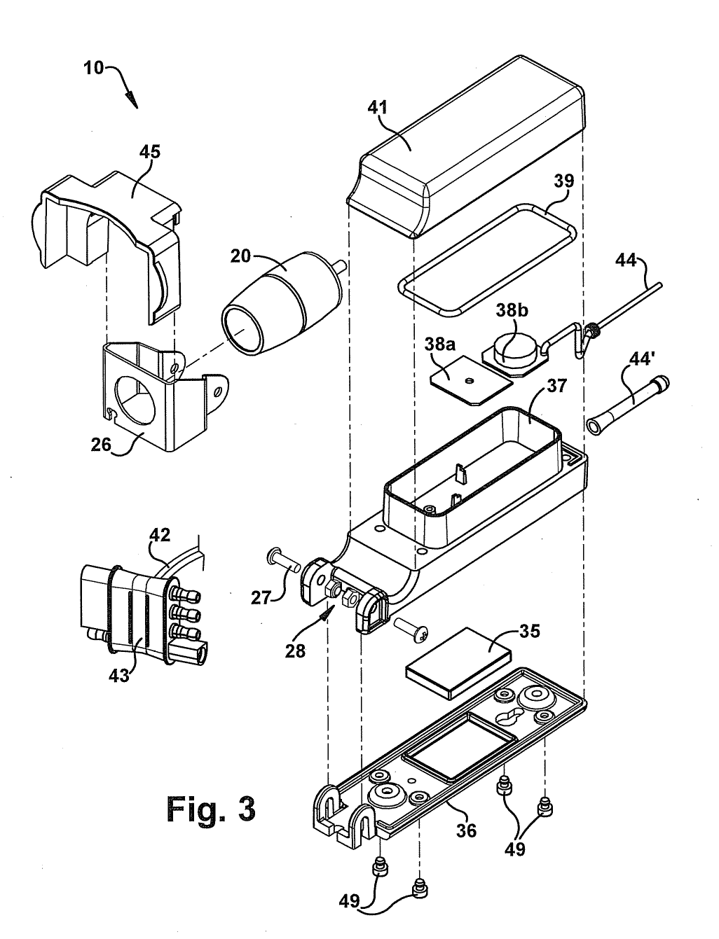

FIGS. 1-6 illustrate various views of an exemplary electrically operable device for mounting to a vehicle. In the illustrated embodiment, an exemplary camera assembly 10 is configured for mounting to a trailer hitch receiver tube 5a, 5b (see FIGS. 2A and 2B). The exemplary camera assembly 10 includes a camera 20 electrically connected with a transmitter 30 having control circuitry (circuit boards 38a, 38b, see FIG. 3) to deliver electrical signals corresponding to images sensed by the camera 20. While the transmitter 30 may be entirely contained within a transmitter housing 32, in one embodiment (as shown in FIG. 3), a transmitter antenna 44 (which may include a protective plastic sheath 44′) may extend from the housing 32 to facilitate wireless delivery of a video signal to a corresponding receiver (e.g., a monitor disposed in the vehicle). The camera 20 may be mounted directly or indirectly to the transmitter housing 32 (which encloses the transmitter circuitry), which is sized to be inserted into the receiver tube 5a, 5b. In the illustrated embodiment, the camera 20 is mounted or secured to a retainer or retainer bracket 26 that is fastened to the housing 32.

As shown, the transmitter housing 32 may be provided with a substantially flat bottom surface to facilitate stable support by the bottom wall of the receiver tube 5a, 5b. The transmitter housing 32 may additionally be sized to be closely received in a receiver tube 5a (e.g., with a substantially square cross-section that substantially matches the cavity of a Class II receiver tube, as shown in FIG. 2A), for example, to minimize lateral movement of the camera 20 with respect to the receiver tube 5a. To facilitate secure positioning of the transmitter housing 32 within a larger receiver tube 5b (e.g., a Class III receiver tube, as shown in FIG. 2B), an adapter 45 may be secured to the retainer bracket 26 (or alternatively, to the housing). As shown in FIG. 1, the adapter 45 may include side walls 46 positioned to closely fit within the side walls of the larger receiver tube 5b. Additionally or alternatively, the adapter 45 may include laterally extending flanges 47 that abut the outer end of the receiver tube to limit the depth of insertion of the transmitter housing 32 within the receiver tube 5b.

To secure the camera assembly 10 to the receiver tube 5a, 5b, the transmitter housing 32 may be shaped to accommodate a hitch pin (or other locking member, not shown) inserted through the aligned holes 6a, 6b of the receiver tube 5a, 5b, such that withdrawal of the transmitter housing 32 from the receiver tube 5a, 5b is blocked by the hitch pin. As one example (not shown), the transmitter housing 32 may be provided with a laterally extending hole positioned to align with the receiver tube holes 6a, 6b for receipt of a hitch pin therethrough. As another example, to facilitate sealing the internal cavity of the housing, an outermost (i.e., facing the open end of the receiver tube) wall of the housing may include a pin engaging surface that aligns with circumferential edges of the mounting holes to secure the housing at least against movement toward the open end of the receiver tube when a hitch pin is inserted through the mounting holes. As shown, pin engaging surfaces of the transmitter housing 32 may be provided in a recessed portion 33 that may be aligned with the receiver tube holes 6a, 6b to accommodate the hitch pin, such that the inserted hitch pin blocks withdrawal of the transmitter housing 32. As shown, the recessed portion 33 may be provided with one or more arcuate surfaces, which may substantially match circumferential edges of the mounting holes (i.e., have matching radii) to engage the cylindrical hitch pin.

In one embodiment, as shown, the recessed portion 33 may be provided with multiple arcuate surfaces sized and positioned to accommodate alignment with receiver pin holes of multiple sizes and positions (with respect to the bottom surface of the receiver tube 5a, 5b), to prevent movement of the housing toward the open end of the receiver tube, away from the open end of the receiver tube, or in both directions. For example, as shown, a first arcuate surface 33a may be positioned to align with the receiver tube holes of a Class II (1.25″) receiver tube (FIG. 2A), and a second arcuate surface 33b may be positioned to align with the receiver tube holes of a Class III (2″) receiver tube (FIG. 2B). In the illustrated embodiment, the first arcuate surface 33a is contoured to engage both outward facing and inward facing surfaces of the hitch pin, thereby preventing movement of the housing both toward and away from the open end of the receiver tube 5a. Conversely, the second arcuate surface 33b is contoured to engage only an outward facing surface of the hitch pin (preventing movement of the housing toward the open end of the receiver tube 5b), with the retainer bracket 26 (with adapter 45) engaging the outer edge of the receiver tube 5b to prevent inward movement of the housing 32.

To allow for varied and secure positioning of the transmitter housing 32 within a receiver tube, a fastening component may be provided to selectively and securely position the transmitter housing 32. While many different fastening components may be utilized (including, for example, clamps, gaskets, and adhesive pads), in one embodiment, the transmitter 30 may be provided with a magnetic component configured to magnetically secure the transmitter housing 32 within the receiver tube 5a, 5b. As shown in the exploded view of FIG. 3, a magnet 35 (e.g., a neodymium iron-boron magnet) may be disposed within the transmitter housing 32 proximate a bottom portion or plate 36 of the housing to magnetically affix the transmitter 30 within the receiver tube 5a, 5b. The magnet 35 may be strong enough to prevent movement of the camera assembly 10 due to vibration or bumping, while allowing for user withdrawal or repositioning of the transmitter 30. A base portion 37 of the transmitter housing 32 may be provided, for example, to isolate the magnet 35 from the transmitter's circuit boards 38a, 38b. A gasket seal 39 (e.g., a silicone gasket) may be provided between the base portion 37 and an upper housing portion 41 to prevent exposure of the circuit boards 38a, 38b to moisture or other contaminants. Any suitable fasteners (e.g., machine screws, not shown) may be used to secure two or more of the transmitter housing components together. Additionally, soft (e.g., rubber) foot pads 49 may be secured to the bottom plate 36 to provide additional grip between the housing 32 and the receiver tube 5a, 5b, and/or to prevent scratching or marring of a vehicle surface to which the housing 32 is attached (magnetically or otherwise).

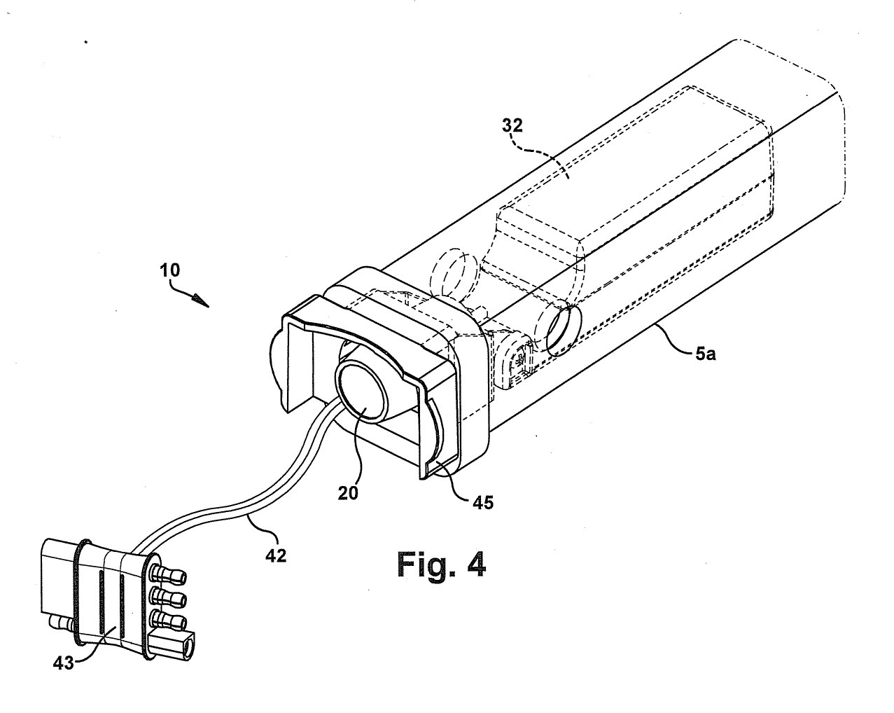

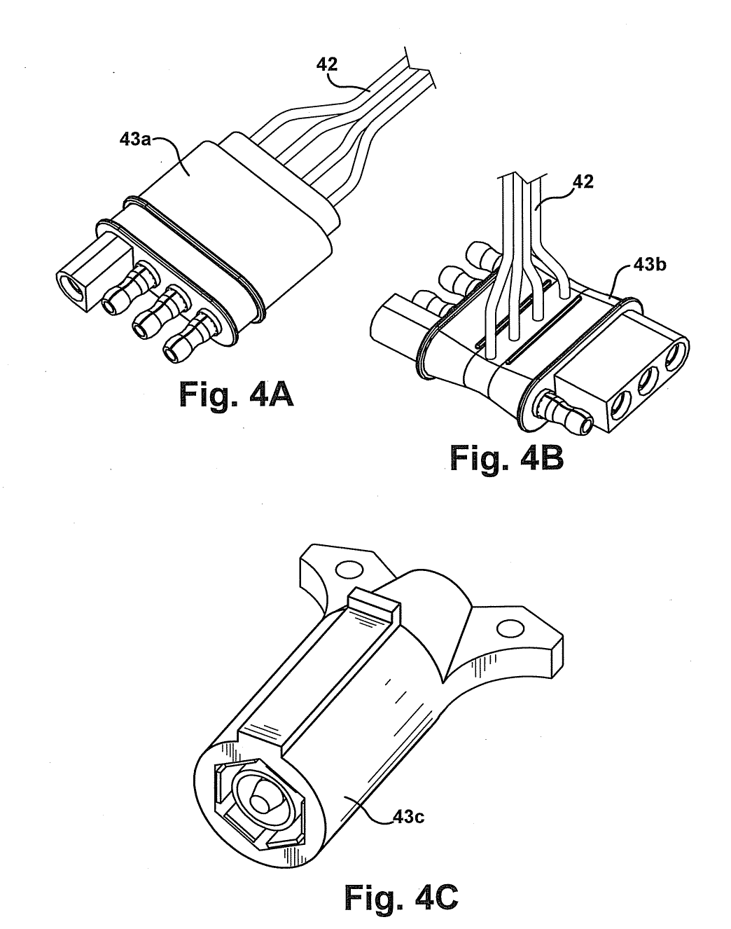

While the camera assembly 10 may be powered by an internal, self-contained battery, in one embodiment, the camera assembly may be electrically connected to the vehicle to which it is mounted, to be powered by the vehicle's battery. As one example, the camera assembly 10 may be electrically connected to a vehicle's power supply by a trailer style tow plug. While many different types of electrical connectors may be utilized, in one embodiment, as shown in FIGS. 3 and 4, electrical wiring 42 connected with the transmitter includes an electrical connector 43. The retainer bracket 26 may include a notch in the front face (see FIG. 3) for accommodating the wiring 42. Many different types of electrical connections may be utilized. In one embodiment, a 4-way flat trailer tow plug 43a (FIG. 4A) may be used. By utilizing a vehicle's 4-way flat connection, power supply to the camera may be tied to illumination of the vehicle head lights, to limit battery draw to periods when the vehicle is in use. In another embodiment, a pass-through plug 43b (FIG. 4B) may be utilized to allow a user to power additional components, such as, for example, a trailer. In still another embodiment, as shown in FIG. 4C, a 7-way round plug 43c (a common connection for Class III towing) may be utilized. By utilizing a vehicle's 7-way round connection, power supply to the camera may be tied to illumination of the reverse lights, to limit use of the camera to situations in which the vehicle is in reverse. In other embodiments, the mounted camera assembly 10 may be configured to be powered in alternative or additional circumstances, for example, when the car is impacted, when a burglar alarm is triggered, or when the user actuates a switch, button, or other such control. This selective powering of the camera assembly 10 may be controlled, for example, by control circuitry in the transmitter 30.

According to another inventive aspect of the present application, a receiver tube mountable camera assembly may be adapted for alternate mounting to a vehicle, for example, for use of the camera when the receiver tube is occupied, for example, with a trailer hitch. As one example, the camera assembly 10 may be secured to a metallic surface of the vehicle by the magnet 35 in the transmitter housing 32 (see FIG. 6). Still other mounting mechanisms or components may be utilized, including, for example, adhesives, brackets, clamps, suction cups, or other such fasteners.

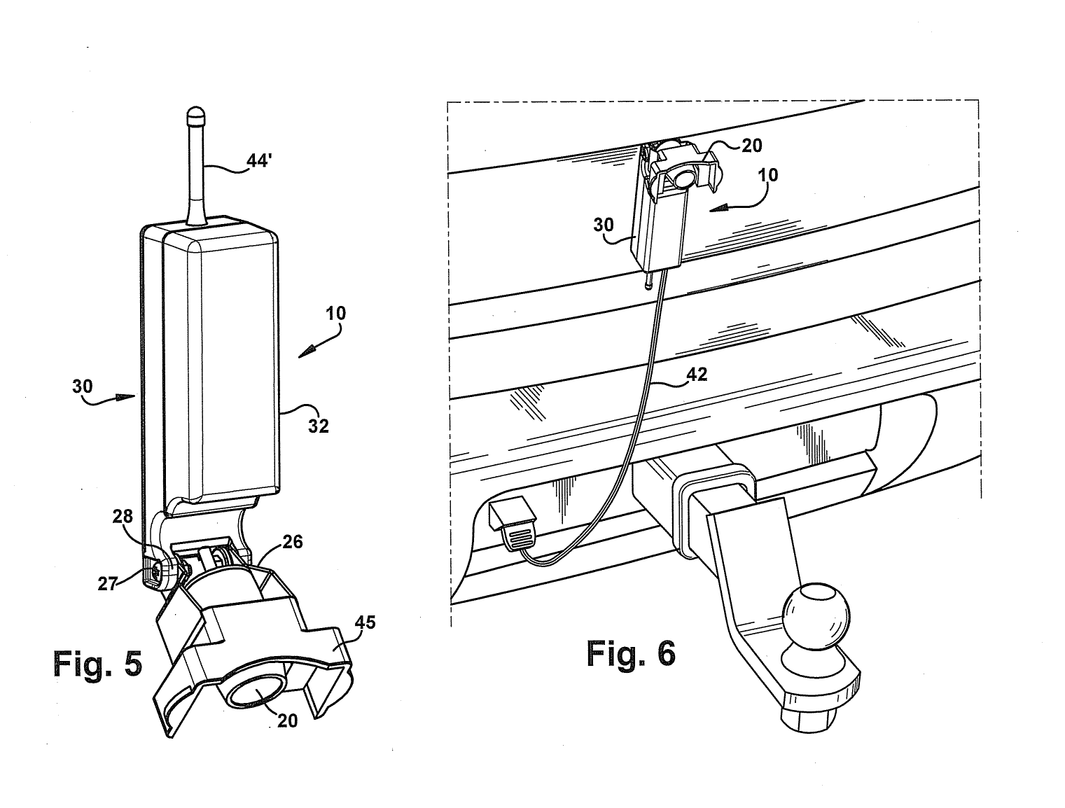

In one embodiment, the orientation of the camera 20 may be adjustable with respect to the transmitter housing (e.g., pivotable, rotatable, or slidable). In the illustrated embodiment, the retainer bracket 26 that supports the camera 20 is pivotably mounted to the transmitter housing 32 (for example, by fasteners 27 assembled with a hinge portion 28), allowing the camera 20 to pivot with respect to the transmitter housing 32 (see FIG. 5). This relationship allows for an adjustable angle of viewing, for example, when the camera assembly 10 is installed with the camera 20 extending outward of the receiver tube, or when the transmitter housing 32 is secured to an external surface of the vehicle (e.g., by magnetic attachment). This may, for example, allow the camera 20 to be directed toward a trailer hitch ball mount to facilitate alignment of the ball mount with a corresponding trailer coupler. As another example, when a trailer is mounted to the vehicle, the camera may be oriented to monitor the condition of the trailer or its contents, and may assist with properly orienting the trailer while the vehicle is turning or backing up.

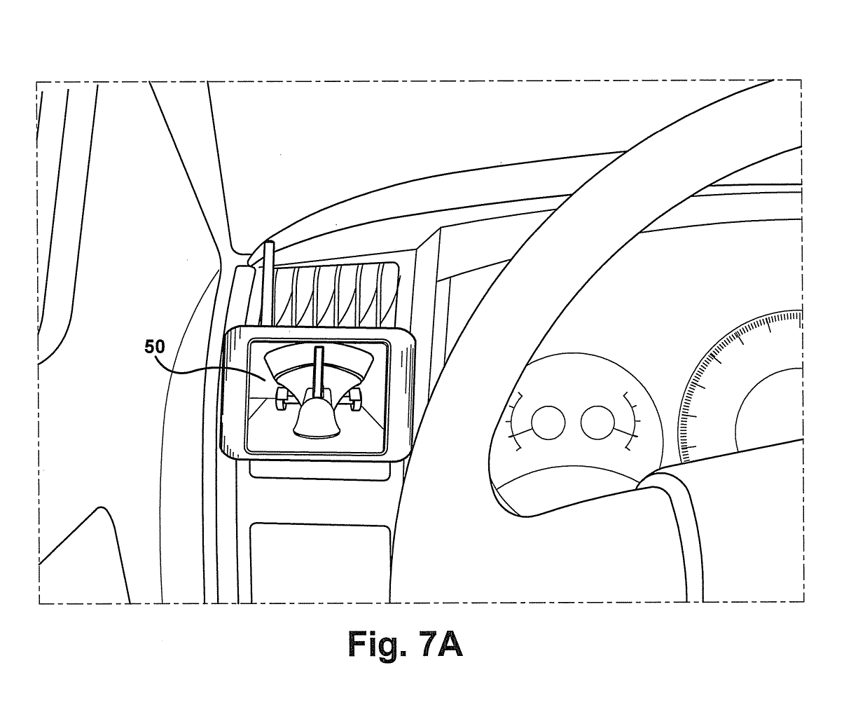

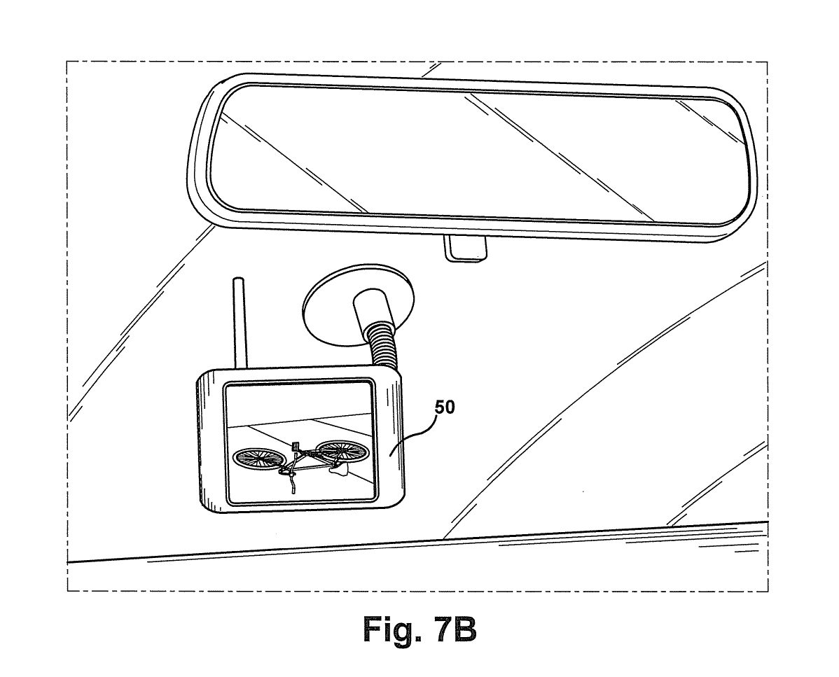

To view the images sensed by the camera 20, the transmitter 30 may deliver corresponding video signals to a display screen 50, which may, for example, be mounted to the vehicle dashboard (see FIG. 7A), windshield (see FIG. 7B), rear view mirror (not shown), or some other location within the vehicle. While the video signals may be delivered by a wired connection, in the illustrated embodiment, the transmitter 30 is configured to wirelessly transmit the video signals to a receiver associated with the display screen 50. The display screen may be powered by an internal battery, or by electrical connection with the vehicle's power supply (e.g., through the vehicle's cigarette lighter). Additionally or alternatively, the transmitted video signal may be recorded for later and/or remote viewing. To maximize the peripheral area visible on the display screen, the camera 20 may be provided with a wide angle lens (e.g., a lens with a 130° viewing angle).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A trailer hitch mountable device for installation in a trailer hitch receiver tube having first and second side walls with aligned mounting holes, the device comprising:
a housing sized to be received in the receiver tube, the housing having an outermost wall including at least a first pin engaging surface positioned to align with circumferential edges of the aligned mounting holes when the device is installed in the receiver tube; and
a retainer bracket secured to the housing and configured to engage an outermost edge of the receiver tube when the device is installed in the receiver tube;
wherein when the device is installed in the receiver tube and a receiver pin is inserted through the aligned mounting holes, the first pin engaging surface prevents movement of the housing toward the outermost edge of the receiver tube, and the retainer bracket prevents movement of the housing away from the outermost edge of the receiver tube.

2. The mountable device of claim 1, wherein the housing further comprises a magnet positioned to secure the housing against movement with respect to the receiver tube when the device is installed in the receiver tube.

3. The mountable device of claim 2, wherein the magnet is disposed between a base portion and a bottom portion, thereby isolating the magnet from an internal cavity of the housing.

4. The mountable device of claim 1, further comprising a camera affixed to the retainer bracket and a wireless transmitter disposed within the housing and in electrical communication with the camera.

5. The mountable device of claim 4, further comprising a transmitter antenna extending from an innermost wall of the housing.

6. The mountable device of claim 1, wherein the retainer bracket is configured to pivot with respect to the housing.

7. The mountable device of claim 1, wherein the outermost wall of the housing further includes a second pin engaging surface adjacent to the first pin engaging surface, wherein the second pin engaging surface is sized to align with circumferential edges of aligned mounting holes of a second receiver tube dimensionally different from the first stated receiver tube.

8. The mountable device of claim 1, wherein the first pin engaging surface comprises an arcuate surface having a radius that substantially matches a radius of the aligned mounting holes.

9. An electrically operable trailer hitch mountable device for installation in a trailer hitch receiver tube having first and second side walls with aligned mounting holes, the device comprising:
a housing sized to be received in the receiver tube, the housing having a pin engaging surface configured to align with circumferential edges of the aligned mounting holes when the housing is received in the receiver tube, the housing further including an internal cavity;
an electrically operable device controller disposed within the internal cavity;
a retainer bracket secured to the housing and configured to engage an outermost edge of the receiver tube when the housing is received in the receiver tube; and
an electrically operable device interface secured to the retainer bracket and in electrical communication with the device controller;
wherein when the housing is received in the receiver tube and the pin engaging surface is aligned with the circumferential edges of the aligned mounting holes and a receiver pin is inserted through the aligned mounting holes, the pin engaging surface prevents movement of the housing toward the outermost edge of the receiver tube.

10. The mountable device of claim 9, wherein the device interface comprises a camera and the device controller comprises a wireless transmitter for delivering video signals to a remote video monitor.

11. The mountable device of claim 9, wherein the housing further comprises a magnet positioned to affix the housing against an internal surface of the receiver tube, the magnet being disposed between a base portion and a bottom portion, thereby isolating the magnet from the device controller.

12. The mountable device of claim 9, wherein at least a portion of the device interface extends into the receiver tube when the device is installed in the receiver tube.

13. A trailer hitch mountable device for installation in either one of a first trailer hitch receiver tube having first and second side walls with aligned first and second mounting holes and a second trailer hitch receiver tube having third and fourth side walls with aligned third and fourth mounting holes, the first and second mounting holes being dimensionally different the third and fourth mounting holes, the device comprising:
a housing sized to be received in either one of the first and second receiver tube, the housing having an outermost wall including first and second pin engaging surfaces, the first pin engaging surface being sized to align with circumferential edges of the first and second mounting holes when the device is installed in the first receiver tube, the second pin engaging surface being sized to align with circumferential edges of the third and fourth mounting holes when the device is installed in the second receiver tube; and
a retainer bracket secured to the housing and configured to engage an outermost edge of the first receiver tube when the device is installed in the first receiver tube;
wherein when the device is installed in the first receiver tube and a receiver pin is inserted through the first and second mounting holes, the first pin engaging surface prevents movement of the housing toward the outermost edge of the first receiver tube, and the retainer bracket prevents movement of the housing away from the outermost edge of the first receiver tube;
further wherein when the device is installed in the second receiver tube and a receiver pin is inserted through the third and fourth mounting holes, the second pin engaging surface prevents movement of the housing toward the outermost edge of the second receiver tube.

14. The mountable device of claim 13, wherein when the device is installed in the second receiver tube and a receiver pin is inserted through the third and fourth mounting holes, the second pin engaging surface prevents movement of the housing away from the outermost edge of the second receiver tube.

15. The mountable device of claim 13, wherein the first receiver tube comprises a Class III receiver tube, and the second receiver tube comprises a Class II receiver tube.

16. The mountable device of claim 13, wherein the housing further comprises a magnet positioned to secure the housing against movement with respect to one of the first and second receiver tubes when the device is installed in the one of the first and second receiver tubes.

17. The mountable device of claim 13, wherein the retainer bracket is pivotable with respect to the housing.

18. The mountable device of claim 13, wherein the first and second pin engaging surfaces comprise first and second arcuate surfaces, the first arcuate surface having a first radius that substantially matches a radius of the first and second mounting holes, and the second arcuate surface having a second radius matching a radius of the third and fourth mounting holes, the first radius being different from the second radius.

19. A vehicle mounted video monitoring device comprising:
a housing sized to be received in the receiver tube, the housing having a pin engaging surface configured to align with circumferential edges of the aligned mounting holes when the device is installed in the receiver tube, the housing further including an internal cavity;
a transmitter disposed within the internal cavity;
a retainer secured to the housing; and
a camera secured to the retainer bracket and in electrical communication with the transmitter for delivering video signals to the transmitter;
wherein the transmitter is configured to deliver the video signals received from the camera to a video monitor in electrical communication with the transmitter;
further wherein when the device is installed in the receiver tube and a receiver pin is inserted through the aligned mounting holes, the pin engaging surface prevents movement of the housing toward the outermost edge of the receiver tube, and the camera is at least partially disposed within the receiver tube.

20. The device of claim 19, wherein the transmitter comprises an antenna extending from a rear surface of the housing.

21. The device of claim 19, wherein the retainer is configured to pivot with respect to the housing, such that the orientation of the camera is pivotally adjustable.
